(19) United States
(12) Patent Application Publication
(10) Pub. No.: US 2009/0284577 A1
(43) Pub. Date: Nov. 19, 2009

(54) VIDEO TELEPHONE SYSTEM AND METHOD

(76) Inventors: Avi Kumar, Cupertino, CA (US); Nathan Hunter Calvert, Austin, TX (US)

Correspondence Address: KUWARE, INC., 1211 W. 8th St, #201, Austin, TX, 78703, US

(21) Appl. No.: 12/120,216

(22) Filed: May 13, 2008

(51) Int. Cl. H04N 7/14

(52) U.S. Cl. 348/14.02; 348/E07.078

(57) ABSTRACT

Videophone systems and methods are provided, both for construction and use of videophones, as well as configuration thereof. A preferred system allows remote users to configure dialing options for a videophone user who may not have PC operation skills or access. A user receives their unit, connects it to the internet or network, and stored configuration data is automatically downloaded for presentation in a menu structure. Remote users may also upload multimedia data such as pictures for automatic download and display by the unit in a format such as a “digital picture frame” feature. A preferred videophone uses a television set for display and a universal remote to control both the television set and the videophone. The remote may have a microphone for receiving the audio portion of videophone calls, and for receiving audio for speech-to-text control of directory or internet search.

### TECHNICAL FIELD

The present invention related to video telephones and, more specifically, to a video telephone system operable through a television set and remote control.

### BACKGROUND

Typical videophone communication systems are expensive to purchase and operate. Recent advances in networked video telephony, such as the quality of service provisions in Internet Protocol version 6 (IPv6) and the H.263 and MPEG-4 video compression standards, have greatly improved the accessibility of video conferencing technology over broadband internet connections.

However, typical, videophones are very complex to use. The setup process is even more complex, especially for non-technical users. Even if a videophone works over the internet, typical videophones are still lack plug-n-play type ease of use. Often videophone users must configure many items such as network proxies, IP addressing, and other configuration items unfamiliar to non-tech savvy users. Users who are unfamiliar with PCs have especially difficult time configuring and using modern videophones.

What is needed, therefore, are videophone systems that operate over the internet and are easy to use for non-technical user population.

### SUMMARY

Videophone systems and methods are provided, both for construction and use of videophones, as well as configuration thereof. A preferred system allows remote users to configure dialing options for a videophone user who may not have PC operation skills or access. A validation scheme is provided to avoid spam configurations. A user receives their unit, connects it to the internet or network, and stored configuration data is automatically downloaded for presentation in a menu structure. Remote users may also upload multimedia data such as pictures for automatic download and display by the unit in a format such as a “digital picture frame” feature.

A preferred videophone unit uses a television set for display and a universal remote to control both the television set and the videophone unit. The remote may have a microphone for receiving the audio portion of videophone calls, and for receiving audio for speech-to-text control of directory or internet search. Search results may be browsed and selected with remote control arrow keys, allowing a greatly simplified user interface over personal computers.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective drawing a videotelephone unit that may rest on top or in front of a television set.

FIG. 2 is a perspective drawing of a videotelephone unit with a television set.

FIG. 3 is a hardware block diagram of a videotelephone unit according to one embodiment.

FIG. 4 is a hardware block diagram of a remote control unit according to one embodiment.

FIG. 5 is a software block diagram of a videotelephone unit according to one embodiment.

FIG. 6 is a system diagram helpful in explaining the videotelephone services according to various embodiments.

FIG. 7 is flow chart of a videophone provisioning and configuration process according to one embodiment.

FIG. 8 is a flow chart of a process for providing media services over a videophone unit.

Like reference symbols in the various drawings indicate like elements.

### DETAILED DESCRIPTION

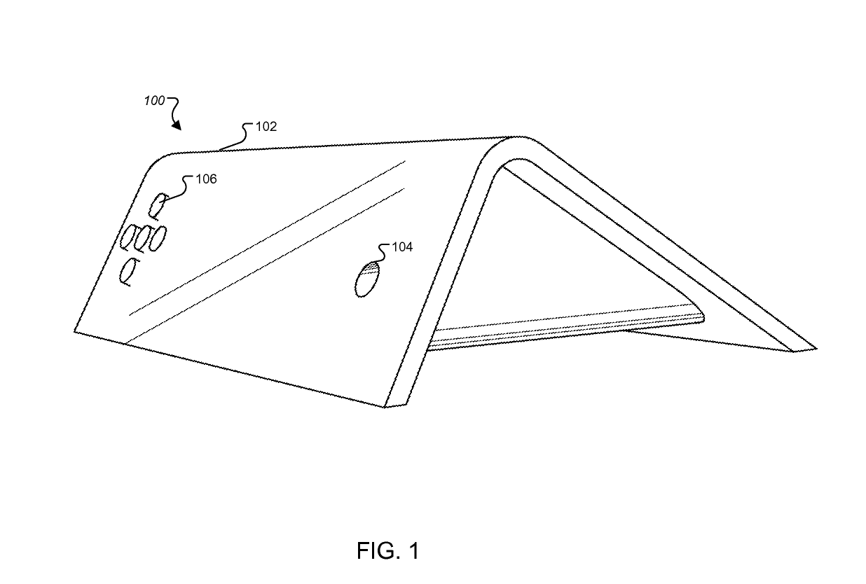

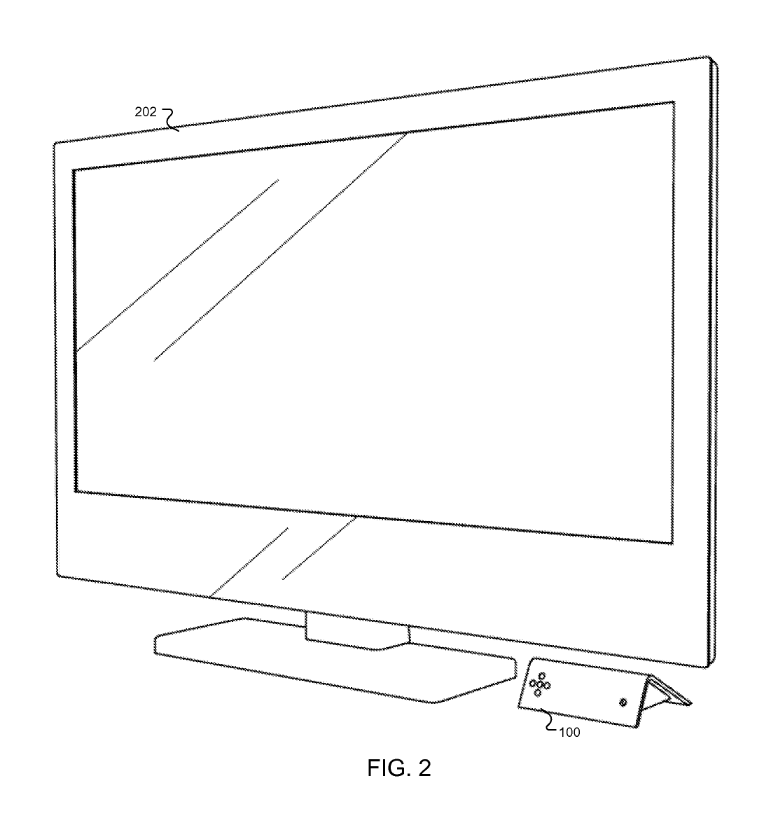

FIG. 1 is a perspective drawing a videotelephone unit 100 that may rest on top or in front of a television set. FIG. 2 is a perspective drawing of the videotelephone unit 100 with a television set 202. Referring to both figures, unit 100 may be placed on a top surface, beside, or in front of the television set 202. Any suitable mounting arrangement may be used.

The unit 100 is generally intended for use paired with a television 202, employing the television as a display. A computer monitor or mixed-use display device is also suitable. Unit 100 connects to the internet or a proprietary network such as a DOCSIS cable data network, or a DSL or 3G/WiMAX wireless data network, to provide interconnectivity. While the depicted unit has some menu navigation buttons 106 (preferably up-down, left-right, and select), a preferred version uses a remote control for user operation.

Not shown are cables that will be used such as an Ethernet cable providing internet connection unit 100, and the video cable connection to television 202 for video display. The depicted unit 100 has a housing 102 which may take on any suitable shape. A video camera 104 is presented along the front surface of housing 102. Menu navigation buttons 106 are also present along the front surface, but this is of course not limiting and any suitable industrial design may be used. Preferably power and status indicators are flush with one surface housing 102.

The depicted unit illustrates an example subscriber setup for a subscriber of a videophone service through a network provider. Although the term subscriber as used herein generally indicates a particular household, the same term is also used to refer the various members of a household or business entity that may use a videophone 100. Preferably, a subscriber setup generally includes videophone interface unit 100 and television or display 202. In this embodiment videophone interface unit 200, a cable modem is also configured to communicate on a Local Area Network (LAN) to provide internet connectivity. Device 100 may connect directly to a cable modem, DSL modem, or other internet modem, or a router or combined device. Although a wired LAN is typically employed, the present invention also contemplates the use of a wireless LAN.

Some embodiments may use a phone trap to integrate the unit 100 with PSTN phone wiring in a household or business. In such embodiment the phone trap communicate via a typical connection interface such as RJ11.

Concerning the video camera 104, in one embodiment the camera is a conventional CCD camera although other suitable camera technologies such as CMOS imaging arrays can also be used. Preferably, videophone 200 provides zoom, pan, and tilt features for the corresponding remote camera. In other words, each person on the call has the capability to zoom, pan, and tilt the camera of the party they are calling. In many videoconferencing systems this function is provided using a camera that has three motors in it—one for zooming, one for horizontal panning, and for vertical tilting. However, such a mechanical solution may be undesirable for a consumer device for several reasons. The cost may be prohibitively high. The potential for malfunctions in the driving mechanisms and control software is always present.

Therefore, one embodiment of videophone 100 includes a fixed camera having a wide-angle lens 104. Behind the wide angle lens 104 is an image array rated higher than the desired image resolution. The camera includes electronics and driver software configured such that camera is operable in several modes. A zoomed-out image mode is provided by taking the entire high-resolution image and converting it to the desired lower target resolution. In a zoom mode, an image is provided using a portion of the high-resolution image. Select areas of the image array can also represent pan and tilt configurations. In one embodiment, the camera is movable or removable to allow viewing of areas not ordinarily in the range of videophone 100, such as a document.

In some embodiments, the system is integrated to work with one or more standard PSTN telephones (or POTS phones) installed in a user's residence. Such an embodiment may use a “phone trap” to ring the phones in the house for incoming video calls. For example, if there were an incoming video call, videophone unit 100 would tell the phone trap to isolate the house's phone lines from the PSTN. Then the phone trap rings the phones with an alternate ring to indicate a video call. If ones of the phones is picked up, the phone trap signals the videophone interface unit 210, which would then accept the incoming video call and begin translating (as a gateway) audio data to and from the videophone caller. Such a system may also be used to accept VoIP calls anywhere in the house through the unit 100 (a known use of phone traps). Construction of phone traps is known in the art.

Videophone 100 includes a flash memory that stores a directory including a plurality of subscriber names and corresponding telephone numbers or other identifiers (which are identifiers for the IP address lookup, not necessarily traditional telephone numbers). In addition, the directory can include one or more images or photos associated with an entry in the directory. The videophone 100 may also be used to display standard directory information retrieved from a server. A button or menu may be used to activate a search service, and then the unit's remote based microphone or built-in microphone may be used to acquire text-to-speech data to complete a search. Navigation through search results is preferably accomplished with arrow keys on the unit's remote control, which is useable by much larger segments of the population than a computer keyboard and mouse, or touchscreen input devices.

Another application that may run on the unit 100 is an advertising application that can downloads banner ads from a server and run them on a designated portion of the screen. Advertisements may also fill most of the screen, for example, during ringtime on an outgoing call. Advertisements may appear in a banner format during the call underneath or beside the incoming video screen. Preferably, the advertising application downloads ads based on geographic location of the user and other collected data. Any suitable type of consumer data may be used. In some instances, the unit 100 may perform running voice recognition on the call and send text information to a server requesting ads relevant to the conversation. For example, discussing brakes could display a current video advertisement or map information a local brake service shop.

As described further below, the unit 100 is preferably an embedded computer with signal processing capability optimized for audio/video. As such, it may also run applications to act as a player for streaming media, and host many other multimedia functions.

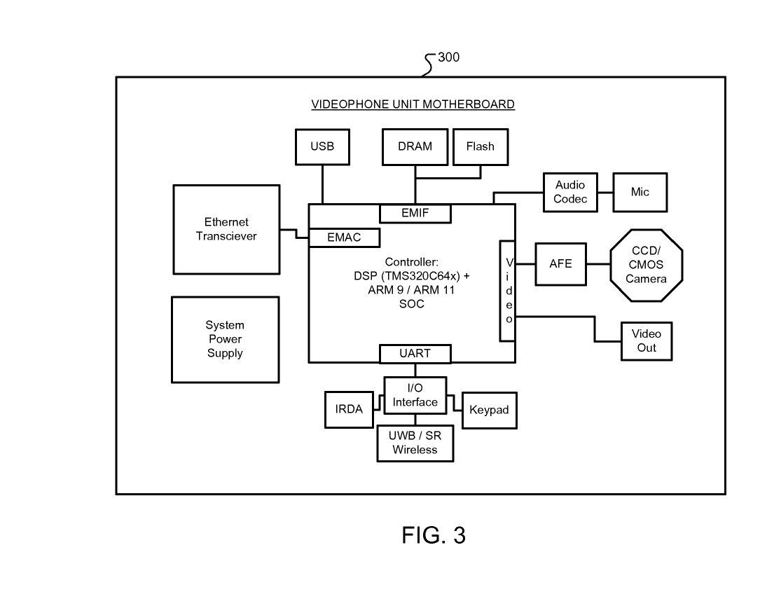

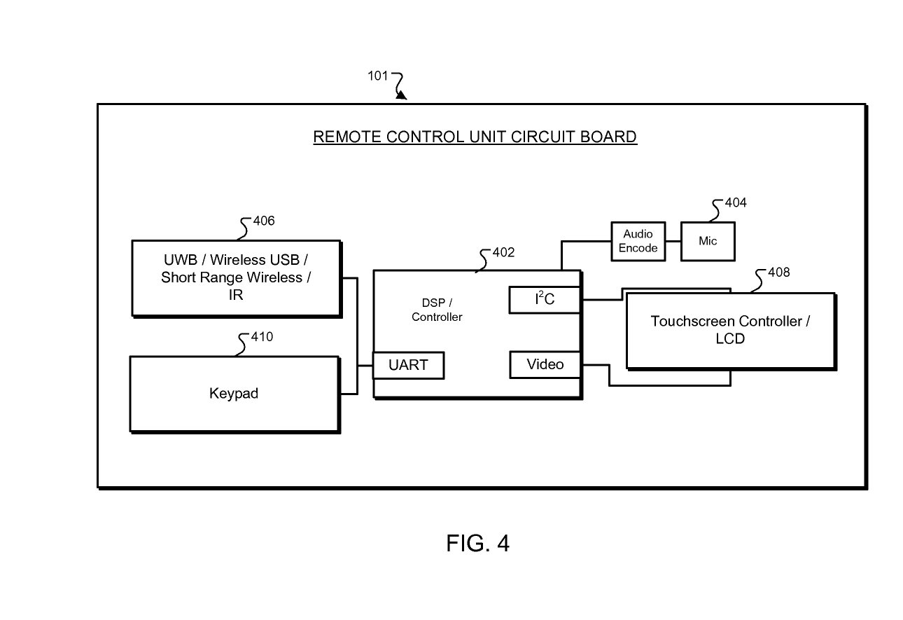

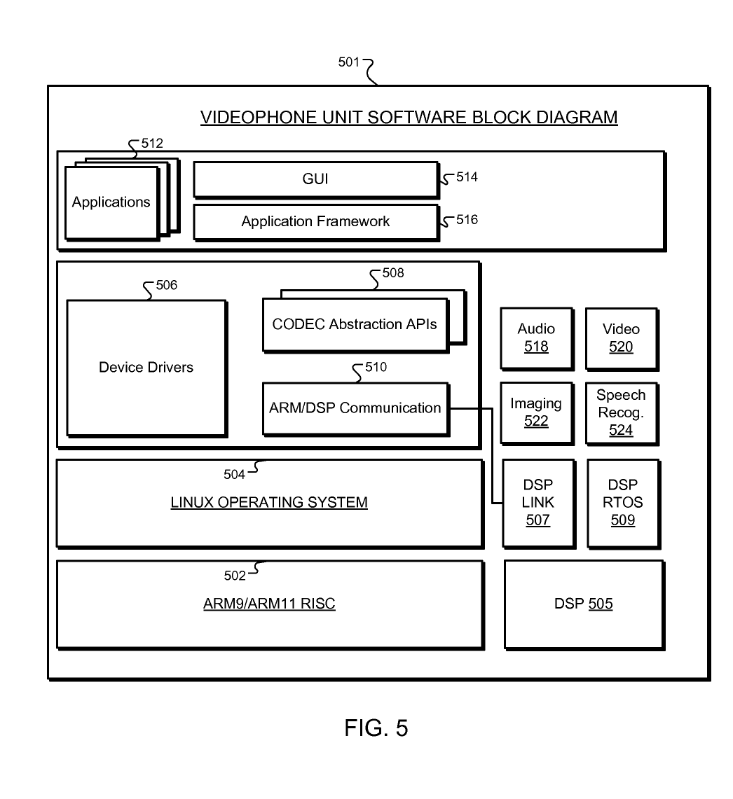

FIG. 3 is a hardware block diagram of a videotelephone unit according to one embodiment. FIG. 4 is a hardware block diagram of a remote control unit according to one embodiment. FIG. 5 is a software block diagram of a videotelephone unit according to one embodiment.

Referring to FIG. 3, a preferred embodiment of the unit 100 motherboard 300 includes uses a system-on-chip solution with an ARM microcontroller and a suitable DSP (such as the integrated TMS320C64x from Texas Instruments). If microcontroller power is such that audio and video functions may be performed in the microcontroller, no DSP may be needed. The depicted SoC architecture is based on a programmable digital signal processor (DSP) with video-specific hardware acceleration providing the computational performance needed for real-time encode-decode and compressiso-decompression algorithms (codecs) and other communications Signal processing. Combining an ARM-design RISC processor wish the DSP adds control and Baser interface support, together with programming ease: and integrated video peripherals in one embodiment, the TMS320DM644x digital media processor is used to provide a hardware foundation with an integrated TMS320C64x DSP and an ARM926EJ-S RISC processor with additional hardware acceleration to perform specific operations frequently used by video codecs. A video processing subsystem includes a front end with an on-chip image pipeline for camera image capture and precessing, supporting both BT.656-compliant devices and CCD/CCMOS sensors. A back end system includes integrated digital-to-analog converters (DACs) provides analog and/or digital

FIG. 5 is a high-level block diagram of software on a preferred version. The stacks on the left and right represent the RISC and DSP software, respectively. The RISC is the master, communicating directly to the DSP 505's realtime operating system 509 (RTOS), through the DSP interprocessor communication software 510. Devices drivers 506 handle functions for the various user I/O and network functionality. CODEC abstraction API's 508 provide control of CODEC functions implemented by the DSP. Note that some of depicted digital data processing domains on the DSP (specifically Audio 518, Video 520) may have their own I/O functionality.

The unit 100's software applications 512 sit on top of the RISC stack, and the underlying operating system (OS) 504, in this case, is Linux. Through use of the DSP Communication functions 510, software code written in C on the RISC sees the DSP as another resource, similar to the peripherals and memory. Since video systems rely heavily on codecs, the interfaces (APIs) to algorithms in each of the four processing domains: audio 518, video 520, imaging 522, speech 514.

In some versions, the system is capable of transcoding—of changing resolutions, encoding schemes and data rates in real time. Transcoding has long been familiar in network infrastructure equipments, but its importance is only beginning to be felt in video conferencing, where it is needed to handle communications among different types of displays, or on networks with different bandwidths. The systems may employ transcoding functionality in audio and video processing areas 518 and 520 to display at one resolution while receiving at another, or using video camera data at once resolution/frame rate while transmitting it in another.

The video data conversion engine 520 manages video processing tasks, including downscaling, other video processing, and menu overlay functionality. Preferably, the video engine 520 has direct access to video ports to simplify design and save interface components, and PCI bus or other internal bus. This may connect directly to the analog front end (AFE) circuitry and the D/A converters used for the video out to the television or display (FIG. 3) Preferably the system uses an MPEG-4 compression with adaptive rate features to transmit video between units, however this is not limiting and any suitable codec/compression scheme may be used.

Referring now back to FIG. 4, a preferred version of the invention uses a remote control to both control the videotelephone unit (and the television), and to hold the microphone for the user side of the videoconference audio. This enables the user to be heard without a far-field microphone housed in the unit 100, which may pick up excessive ambient noise. Preferably, the user may activate and terminate calls using the remote, but selecting menu functions presented on the TV screen.

The depicted remote control unit circuit board shows one design to implement such a remote control. The remote control unit 101 includes a DSP/microcontroller 402 which generally controls functioning of the remote. While a controller and peripheral ICs are shown, other embodiments may use an ASIC with these circuits integrated into the controller package. The remote keypad 410 preferably includes standard TV/DVD/Cable box function buttons and numbers, allowing the remote 101 to act as a universal remote for the user as well as control the videotelephone unit 100. Preferably the videophone functions are controlled through navigation button selection of menus, although any particular function described herein may also have a specific button on keypad 410.

A communications module 406 operatively coupled to controller 402 provides the connectivity to the videophone unit 100. Preferably, remote functions are achieved through IRDA or other remote IR standard known in the art. Module 406 also preferably includes a short range wireless transceiver to transmit digital audio from the remotes built in microphone 404. This transceiver may use any of a number of suitable short range wireless standards presently preferred among these are wireless USB, which may be configured with appropriate range and throughput for the audio use intended. Ultra-wideband, 802.11g or n, or other suitable short range wireless options may be used.

In some embodiments, the remote control 10 1 may have all or a portion of the controls presented thereon through the use of a touchscreen 408 instead of an array of buttons. In such case a secondary video display may be shown on the screen during videophone sessions to display the incoming video (the same video shown on the TV screen). The video is transmitted digitally from unit 100 to the remote via the short range wireless transceiver 406.

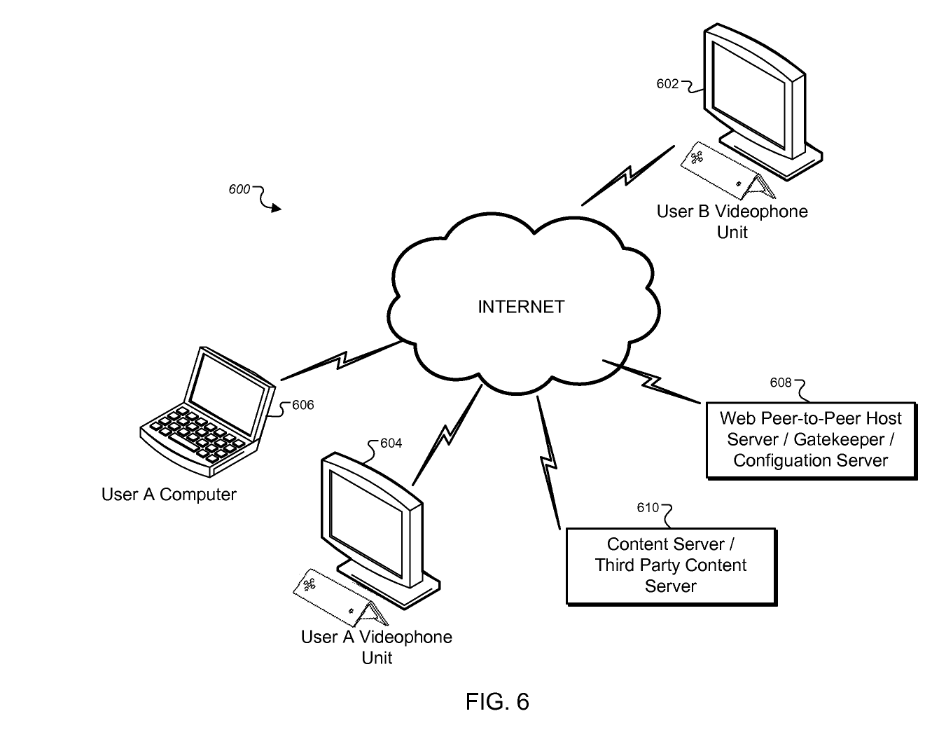

FIG. 6 is a system diagram helpful in explaining the videotelephone services according to various embodiments. Depicted are two videotelephone systems 602 and 604, which will be used to explain example scenarios herein. The system provides a configuration capability for users who may be non-tech savvy, such as, for example, rural areas in developing countries, or users who have never used a PC. Typically, such users are familiar or more comfortable with a television remote control than other types of electronics interfaces. Such users may, in many cases, have relatives abroad or in remote cities, such as children and grandchildren who wish to communicate frequently. This is especially true in countries with large expatriate populations.

In the example system shown, the tech-savvy user is user A, who also has an internet-connected computer (as well as, or in lieu of the videophone unit 604). In the scenarios described below, user A is able to configure the dialing options for user B, who is less familiar with electronics. User B is then able to make and receive calls on their unit with the remote control.

Also included in system 600 are a web peer-to-peer host server and a content server. The peer-to-peer host server 608 hosts the service by keeping track of which users are online and available, and tracking their public IP address (which may change through dynamic IP allocation). The system provides connecting information to the terminals and, in some embodiments, facilitates call set up and tear down instructions. Preferably, the system is managed according to the H.323 set of protocols providing for videoconferencing. Server 608 fits into the H.323 system as a Gatekeeper. Some H.323 terminology is explained below in context of the preferred embodiment.

H.323 refers generally to an umbrella Recommendation from the ITU Telecommunication Standardization Sector (ITU-T) that defines various protocols to provide audio-visual communication sessions on any packet network. The scheme is widely implemented by voice and video conferencing equipment manufacturers, and is widely deployed worldwide. The H.323 group of protocol definitions is hereby incorporated by reference for all purposes.

Starting and ending calls in H.323 (known as Call Signaling), is based on the ITU-T Recommendation Q.931 protocol and is suited for transmitting calls across networks using a mixture of IP, PSTN, ISDN, and other network types. Devices such as the units 100 herein are referred to as Terminals under the H.323 scheme. Inside an H.323 terminal is the “protocol stack,” which implements the functionality defined by the H.323 system. Besides the user Terminals, the H.323 scheme also defines other devices that may appear on the network and work together in order to deliver conferencing capability. Those elements are, Multipoint Control Units (MCUs), Gateways, Gatekeepers, and Border Elements. Some of these are described here for ease of reference.

A Multipoint Control Unit (MCU) is responsible for managing multi-user conferences such and is comprised of two logical entities referred to as the Multipoint Controller (MC) and the Multipoint Processor (MP). Referring to typical conference terms, the MCU is a conference bridge not unlike the conference bridges used in the PSTN today. Its main use is to mix audio (since typical current videoconference systems do not combine video signals other than splitting a screen between multiple video pictures). However, is that H.323 MCUs might be capable of mixing or switching video, in addition to the normal audio mixing done by a traditional conference bridge. Some MCUs also provide multipoint data collaboration capabilities. What this means to the end user is that, by placing a video call into an H.323 MCU, the user might be able to see all of the other participants in the conference, not only hear their voices.

Gateways are devices that enable communication between H.323 networks and other networks, such as PSTN or ISDN networks. One party in a conversation may need a gateway if they are using a terminal that is not an H.323 terminal, and then the call must pass through a gateway in order to enable both parties to communicate. Gateways are widely used today in order to enable the normal PSTN phones to interconnect with the large, international H.323 networks that are presently deployed by many services providers and enterprises.

Gateways are also used in order to enable videoconferencing devices based on H.320 and H.324 to communicate with H.323 systems. Many third generation (3G) mobile networks currently deployed at the time of this filing use the H.324 protocol and are able to communicate with H.323-based terminals in corporate networks through such gateway devices.

A Gatekeeper, such as the peer-to-peer host server 608 in FIG. 6, is an optional component in the H.323 network that provides a number of services to terminals, gateways, and MCU devices. Those services include endpoint registration, address resolution, admission control, user authentication, and so forth. Of the various functions performed by the gatekeeper, address resolution is the most important as it enables two endpoints to contact each other without either endpoint having to know the IP address of the other endpoint on. Gatekeepers may be designed to operate in one of two signaling modes, namely “direct routed” and “gatekeeper routed” mode. Direct routed mode is more efficient and more widely deployed. In this mode, endpoints utilize the RAS protocol in order to learn the IP address of the remote endpoint and a call is established directly with the remote device. In the gatekeeper routed mode, call signaling always passes through the gatekeeper. While the latter requires the gatekeeper to have more processing power, it also gives the gatekeeper complete control over the call and the ability to provide supplementary services on behalf of the endpoints. The preferred mode used herein is direct routed.

A collection of endpoints that are registered to a single Gatekeeper in H.323 is referred to as a “zone.” This collection of devices does not necessarily have to have an associated physical topology. Rather, a zone may be entirely logical and is arbitrarily defined by the network administrator. In this manner in the system in FIG. 6, a zone may connect users all over the world, even if they are using different internet service providers. Gatekeepers have the ability to neighbor together so that call resolution can happen between zones. Neighboring facilitates the use of dial plans such as the Global Dialing Scheme. Dial plans facilitate “inter-zone” dialing so that two endpoints in separate zones can still communicate with each other. In embodiments of the invention where local ISPs are also videophone service providers, the zone scheme may be used to coordinate calls between providers or zones within a provider.

While H.323 is discussed herein, other embodiments employ another popular protocol for voice and video conferencing, the Session Initiation Protocol (SIP). This is a signaling protocol widely used for setting up and tearing down multimedia communication sessions such as voice and video calls over the Internet.

Also depicted in FIG. 6 is a content server 610, which may (like the gatekeeper 608) be a third party content server or may be provided by internet service provider of one or more of the parties. By content provider it is meant that digital content is hosted at the provider for delivery to the users of the system. For example, the system may provide a “digital picture frame” capability allowing the television to display remotely uploaded pictures from user A on user B's television set. This is especially useful for users who have grandchildren living remotely. This and other scenarios of use for the depicted system 600 are further described below.

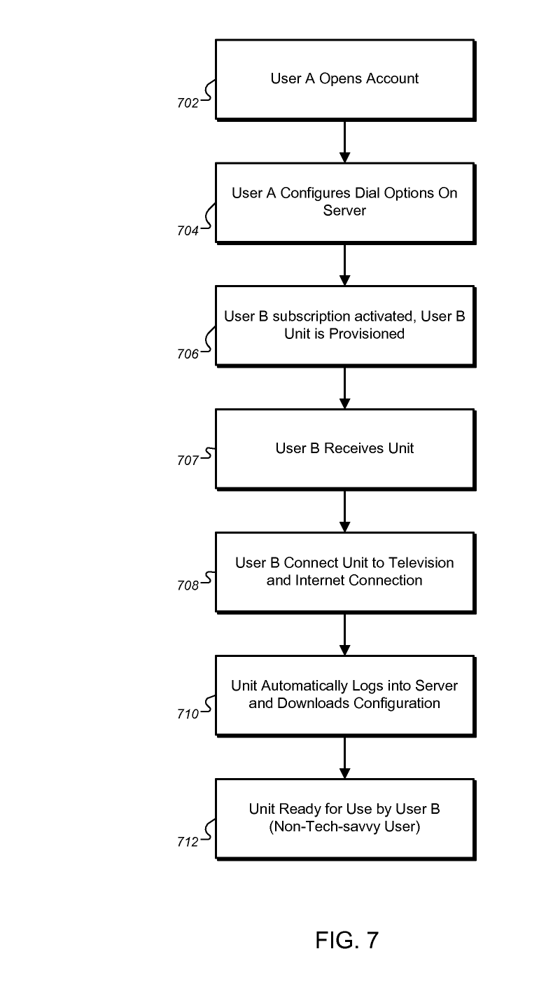

FIG. 7 is flow chart of a videophone provisioning and configuration process according to one embodiment. Provisioning refers to the registration of devices for operation on the network, and the allocation of network resources to devices. Provisioning may be complicated in some internet videotelephony systems because the individual users' (for example A and B in FIG. 6) internet service providers (ISPs) may or may not be a service provider for videotelephone calls. The examples herein can apply both to systems where the ISP is also a videotelephony service provider, and where a third party is the videotelephony service provider.

In FIG. 7 at step 702, User A opens an account with a videotelephony service provider, desiring to make videophone calls to user B. User A, if you will remember, has a PC and is more technologically savvy than user B, who may have difficulty accessing or using a PC, or other devices with similarly complex input/output means. The account user A opens in step 702 may be a joint account, providing paid-up usage of the system for both users, or may be a singular account for user A.

In any event, user A wishes to provide an easy means for user B to call them. This is accomplished by registering as a target or preferred number that user B will call. The registration process involves first identifying user B. This may happen in a number of ways. First, user A may initially purchase videotelephone service for user B in a scenario such as a family plan. In that case, user A is authorized to set up frequently dialed numbers for user B, which are later downloaded to configure user B's unit in step 710. For a case where user B is not part of user A's subscription, a directory may be used for user A to look up user B's dial in number, preferably referred to by name and address, which is mapped to the MAC address or other unique identifier for user B's device. In this case, there arises a problem of trust for third parties. That is, how to keep spammers and other users from registering as a preferred dialed party in user B's account. The problem is exacerbated in the target scenario where user B is not a technically savvy user and therefore may not be able to understand that such abuse has occurred until extraneous parties show up in their dialing configuration.

The trust problem can be resolved using one or more approaches below, which may be more effective when combined. A first solution is only allowing remote party configuration when users are on a common subscription. This would typically happen in the scenario where user A pays for user B's subscription. Second, an approval or access mechanism such as a password provided to user B may allow access to other's to update user B's preferred dialout settings. However, this only complicates the process by requiring an additional step for user B to record and pass on a password, or to approve settings modifications. Given that the main target is the non-savvy user with no PC, this solution is not preferable. A third solution to avoid spam and abuse is simply to allow third party listings, but charge a “validation” fee to avoid spamming. This onetime fee is paid through the server 608 or through user A's subscription bill, and allows user A to enter their number for download into user B's preferred dial settings. This solution is helpful because first the payment avoids spam because spammers cannot afford to pay the validation fee. Depending on the economic situation of the users, a validation fee may effectively deter spam and abuse even when set very low.

After step 704 in which user A configures a frequently dialed number setting to target their own device, that setting is saved on the server as configuration data. In step 706, user B's unit is activated and provisioned. This involves the first login of the unit, which may be by service personnel first configuring the device either at a service center or at user B's residence. Note that a service center may be used when provisioning does not depend on location, but rather the MAC or other identifier of the unit. The unit may also be shipped to user B and automatically provisioned upon its first activation and connection to the internet or other network. In step 707, user B receives their unit. As explained, this may happen outside the depicted order.

In step 708, when user B connects their unit to the television 202 and the internet connection, this cases an automatic configuration step from the server 608 in step 710. The unit has been preset to login with the server upon activation and download its frequently dialed number configuration. These numbers now appear as selection options that will dial out for user B in a single step, preferably at or near the top level of the menus, and easily accessible by user B. After such download, the unit is now ready for user B's use at step 712.

While frequently dialed numbers are configured in this example, other configuration options are possible. User A may configure certain services or content to appear on the television display for user B. For example, user A may upload pictures or video to a content server and set user B's unit to display these pictures using the television as a digital picture frame.

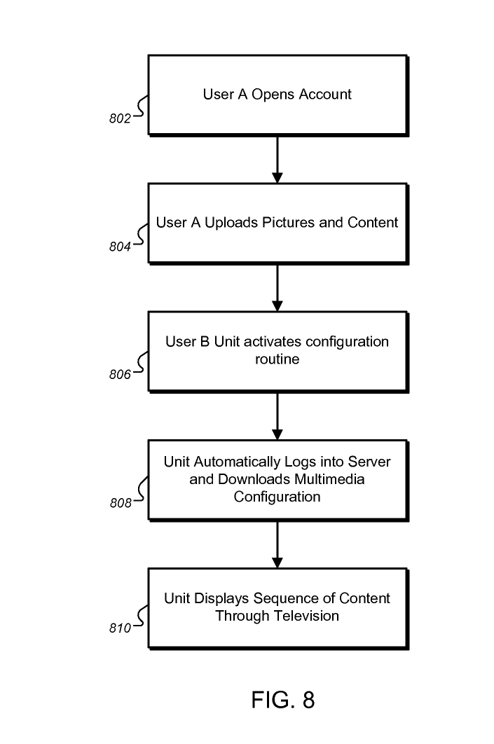

FIG. 8 is a flow chart of a process for providing media services over a videophone unit. User A opens an account, which may include service for user B, in step 802. In step 804, user A uploads certain content to be viewed by user B. The content, typically digital media files, is uploaded and saved on the server. In step 806, user B's unit activates a regular configuration update routine in its application software. This routine typically is set to occur when the unit is turned on, connected to the internet, or at regular intervals thereafter. At step 808, the unit automatically downloads the multimedia content from the server, preferably with a configuration as to the display order or scenario. The server may provide user A the ability to order pictures or video as a “slideshow” back at step 804. After download, at step 810 the unit displays the sequence of content, such as a digital picture frame, upon entering a media display mode. This may be activated by user B as a menu option when content is available, or as a screen saver mode, for example. A menu item may change color or text to indicate new pictures or content have been downloaded and are available for viewing, or a voice prompt may indicate the same.

As shown in FIG. 6, a video telephone system according to one embodiment is shown communicating on the internet. However, other networks may be used and typically a local ISP network (not shown separately) would be present for each user. In many cases, the ISP is a cable, DSL, fiber optic, or 3G or higher wireless network. Units 100 in such cases may be integrated with the internet modem, such as the cable modem, DSL modem, or wireless access modem. In such cases, the unit will includes modem hardware and be configured to communicate via the provider communications network such as a Cable Television (CATV) network, an xDSL network, a WAN, LAN or other wired or wireless network (referred to generally herein as a “broadband network”). Although there are different topologies and technology suppliers for these communication networks components, they all typically have a similar architecture known in the art. For example, in the case of the CATV network connection for both the called and the calling party will include an incoming coax cable, a splitter and a cable modem located at the subscriber's home. For traditional video services, the television 202 will also be connected to splitter, either directly or through a cable converter. In addition, various headend components are also involved, such as a cable modem termination system (CMTS) located at the CATV headend or hub of the CATV system, and a router to direct or route the data packets through and between multiple networks. The CMTS also provides connectivity between the Internet and cable modem. In embodiments where the ISP is also the provider of video phone services, then one or both of the servers 608 and 610 may reside on the providers IP backbone. In such case, the servers are preferably internet connected to broaden the possible subscriber base, but a closed system is also possible in other variations of the present invention.

Correspondingly, for an xDSL network there are also three main components, in this case, however, an xDSL modem is substituted for a cable modem and a Digital Subscriber Line Access Multiplexer (DSLAM) is substituted for the CMTS. The DSLAM is a system located at the phone company's central office or headend that links many customer xDSL modems and converts the signals from those modems to a signal that can be sent across the Internet.

These access network products are widely available from multiple sources and known in the art. In particular, the design and operation of CMTS products are defined in an industry specification known as the Data-Over-Cable-Service Interface Specification (DOCSIS). Current releases of this specification have however been expanded to include methods to support voice communications. In particular, enhancements have been added to support embedded signaling for quality of service and to increase the availability of upstream bandwidth. The CATV industry has also introduced an additional specification known as PacketCable to provide data and communication services. The teachings of these specifications are incorporated herein by reference. Furthermore, various signaling protocols and standards are also incorporated into these specifications, including but not limited to, DiffServ, H.245, H.248, H.263, H.264, H.323, RTP, UDP, SIP, and SS7. These specifications, protocols, and standards are beyond the scope of the present disclosure but are known in the art. In particular, the SIP standards referenced above provide for traditional and enhanced telephone functionality such as call waiting, caller id, and call answering, for example. To provide this phone functionality, a CATV or xDSL system will typically include various administrative components, including provisioning servers, tracking and billing servers, and traffic control servers. These components and technologies are also known in the art.

A number of embodiments of the invention have been described. Nevertheless, it will be understood that various modifications may be made without departing from the spirit and scope of the invention. For example, various construction materials may be used. Further, other techniques besides the depicted neck and head designs may be employed to do center of gravity shifting. Accordingly, other variations are within the scope of the following claims.

What is claimed is:

1. A method of configuring a videophone unit comprising:
receiving, from a first user, an indication to enter dialing information for the first user into stored dialing data for a second user;
receiving an automatic request from a second user videophone unit for configuration data;
transmitting the dialing information for the first user to the second user videophone unit;
storing the dialing information in memory at the second user videophone unit; and
providing a selection option to the second user to dial the first user according to the stored dialing information.

2. The method of claim 1 further comprising receiving a validation input from the first user and, after receiving the validation input, storing the dialing data on a server.

3. The method of claim 2 wherein the validation input is related to a monetary payment.

4. The method of claim 2 wherein the validation input is for the purpose of avoiding spamming.

5. The method of claim 1 further comprising receiving additional configuration information from the first user and storing the information in memory at the second user videotelephone unit.

6. The method of claim 1 further comprising:
receiving multimedia data from the first user and storing the multimedia data in memory at the server; and
upon automated request from the second user videophone unit, transmitting the multimedia data to the second user videophone unit.

7. The method of claim 6 further comprising causing the multimedia data to be displayed by the second user videophone unit.

8. A videophone apparatus comprising:
a video camera;
a video input circuit adapted to receive first video data from the camera;
a wireless receiver circuit adapted to receive first audio data from a remote control device and, either the same or an additional wireless receiver circuit adapted to receive control instructions from the remote control device;
a network communication circuit adapted to transmit the first audio data, or a processed version thereof, and the first video data, or a processed version thereof, to a remote device for playing to a remote user; wherein the network communication circuit is further adapted to receive second video data and second audio data from the remote device; and
a video output circuit adapted to transmit the second audio data, or a processed version thereof, and the second video data, or a processed version thereof, for display on a television set.
